(19) United States
(12) Patent Application Publication
(10) Pub. No.: US 2017/0021804 A1
(43) Pub. Date: Jan. 26, 2017

(54) Programming a Remote Access Device with a Vehicle

(71) Applicant: SECURED MOBILITY, LLC, Georgetown, TX (US)

(72) Inventor: Emmanuel Enrique Lopez, Georgetown, TX (US)

(21) Appl. No.: 15/285,698

(22) Filed: Oct. 5, 2016

Related U.S. Application Data
(63) Continuation of application No. 14/212,677, filed on Mar. 14, 2014, now abandoned.
(60) Provisional application No. 61/792,010, filed on Mar. 15, 2013.

(51) Int. Cl. B60R 25/24; G08C 17/02

(52) U.S. Cl. CPC B60R 25/24; G08C 17/02; B60R 2325/40; G08C 2201/92; B60R 2325/205

(57) ABSTRACT

A computer storage medium encoded with a computer program for programming a remote access device with an access system of a plurality of vehicle types. The computer program comprises instructions that, when executed by a handheld device, cause the handheld device to guide the user to program the access system and sends signals to initiate the programming sequence.

### CROSS-REFERENCE TO RELATED APPLICATIONS

This application is a continuation of U.S. application Ser. No. 14/212,677, filed Mar. 14, 2014, which claims priority to U.S. Application Ser. No. 61/792,010, filed on Mar. 15, 2013, the disclosures of which are expressly incorporated herein by reference in their entirety.

### BACKGROUND

Wireless signal transmitter-receiver systems are employed in a variety of security systems and remote activation systems. Remote access devices are generally used in the automotive industry to activate and deactivate vehicle access systems. Remote access devices can also perform other tasks including remote starting, locking and unlocking doors, unlatching trunk decks or tail gates, opening windows or doors and operating convertible top mechanisms.

3^{rd} parties may want to make universal replacement remote access devices. However, such devices may not always operate compatibly with every type of vehicle.

### SUMMARY

This specification describes technologies relating to programming a remote access device with a vehicle.

In general, one innovative aspect of the subject matter described in this specification can be embodied in methods performed by a device comprising a processor and a display, for programming a remote access device with a vehicle. The device downloads one or more instructions sets and one or more communication procedures from a server. The device identifies a vehicle type for the vehicle from a plurality of vehicle types and selects, based on the identified vehicle type, a communication procedure operable with an access system of the vehicle. The device uses the selected communication procedure to initiate a programming mode with the access system and displays, on the display, instructions to a user describing how to program the remote access device with the access system.

In some implementations, the device may store a plurality of communication procedures to communicate with different access systems of different vehicle types. It may also store a plurality of instructions describing different ways to program remote access devices of different vehicle types.

In some implementations, the selected communication procedure comprises transmitting a wireless signal to the access system.

In some implementations, a different communication procedure of the plurality of communication procedures comprises transmitting a wired signal through an on board diagnostic port to the access system.

In some implementations, the selected communication procedure comprises transmitting a wireless signal to an intermediary device that transmits another signal to the access system upon receiving the wireless signal.

In some implementations, the intermediary device is physically coupled to the access system and the another signal that it transmits is a wired signal. Transmitting a wireless signal can comprise transmitting a first wireless signal to a wireless station, the wireless station configured to transmit a second wireless signal to the intermediary device.

In some implementations, the intermediary device, coupled to the access system via an on board diagnostic port, requests a status report from the access system and sends the status report to the device. The device receives a status report from the access system through the intermediary device.

Another aspect of the invention features a handheld communication device. The handheld communication comprises an input system configured to identify a vehicle type, a display screen configured to display one or more instructions, a memory configured to store a plurality of communication procedures and a plurality of instructions, and a processor configured to select a communication procedure from among the plurality of communication procedures for use with the identified vehicle type. The processor is configured to select an instruction from the plurality of instructions describing how to program an access system of the identified vehicle type. The handheld communication device also comprises a communication system configured to implement a selected communication procedure to program a remote access device with the access system, the communication system also configured to communicate wirelessly with other handheld communication devices.

In some implementations, the memory is further configured to store a plurality of communication procedures to communicate with different access systems of different vehicle types, and the memory is also configured to store a plurality of instructions describing different ways to program remote access devices of different vehicle types.

In some implementations, the selected communication procedure comprises transmitting a wireless signal to the access system.

In some implementations, a different communication procedure of the plurality of communication procedures comprises transmitting a wired signal through an on board diagnostic port to the access system.

In some implementations, the selected communication procedure comprises transmitting a wireless signal to an intermediary device, the intermediary device configured to transmit another signal to the access system upon receiving the wireless signal.

In some implementations, the intermediary device is physically coupled to the access system. The another signal can be a wired signal. Transmitting a wireless signal to the intermediary device can comprise transmitting a first wireless signal to a wireless station, the wireless station configured to transmit a second wireless signal to the intermediary device.

In some implementations, the communication system is configured to receive a status report from the access system. The intermediary device is coupled to the access system via an on board diagnostic port and is configured to request the status report from the access system and also configured to send the status report to the device.

Another aspect of the invention features a computer storage medium encoded with a computer program for programming a remote access device with an access system. The computer program comprises instructions that, when executed by a handheld device, cause the handheld device to perform operations. The operations comprise displaying, on a screen of the handheld communication device, a input menu for selecting a model of vehicle from a plurality of models of vehicles. They also comprise selecting a communication procedure operable with an access system of the selected model and using the selected communicating procedure to initiate a programming mode of a vehicle. They also comprise displaying instructions describing how to program the remote access device with the access system.

In some implementations, the operations further comprise storing a plurality of communication procedures to communicate with different access systems of different vehicle types and storing a plurality of instructions describing different ways to program remote access devices of different vehicle types.

In some implementations, using the selected communication procedure comprises transmitting a wireless signal to the access system.

In some implementations, a different communication procedure of the plurality of communication procedures comprises transmitting a wired signal through an on board diagnostic port to the access system.

In some implementations, the selected communication procedure comprises transmitting a wireless signal to an intermediary device, the intermediary device configured to transmit another signal to the access system upon receiving the wireless signal.

In some implementations, the intermediary device is physically coupled to the access system. The another signal is a wired signal. Transmitting a wireless signal to the intermediary device comprises transmitting a first wireless signal to a wireless station, the wireless station configured to transmit a second wireless signal to the intermediary device.

Other embodiments of this aspect include corresponding systems, apparatus, and computer programs, configured to perform the actions of the methods, encoded on computer storage devices. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the actions.

Particular embodiments of the subject matter described in this specification can be implemented so as to realize one or more of the following advantages: Vehicle owners needing to program a remote access device with the access system of their vehicle can conveniently use a portable handheld device to do so instead of going to a dealership. An application gives the vehicle owner instructions on how to perform the programming sequence without a needing a technician.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a handheld communication device for programming a vehicle access system.

FIG. 2 shows a flowchart of a method performed by a handheld communication device.

FIGS. 3A and 3B show a handheld communication device programming a vehicle access system for operation with a remote access device.

FIG. 4 shows a handheld communication device programming, through an intermediary device, a vehicle access system for operation with a remote access device.

FIG. 5 shows a handheld communication device programming, through an intermediary service, a vehicle access system for operation with a remote access device.

FIG. 6 shows a handheld communication device programming, through an intermediary service, a vehicle access system for operation with a remote access device.

FIG. 7 shows a flowchart of an application interface.

### DETAILED DESCRIPTION

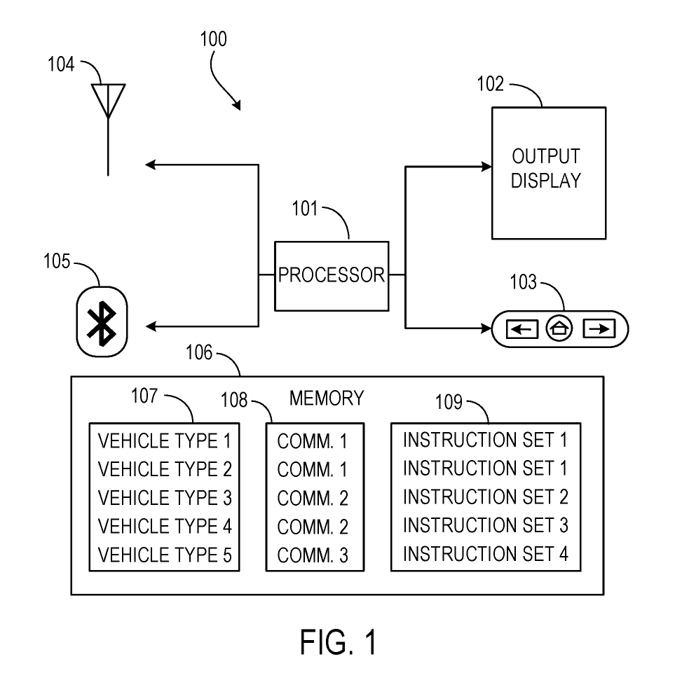

FIG. 1 is a block diagram of an example handheld communication device 100 for programming a vehicle access system. The device has a processor 101, output display 102, input buttons 103, antenna 104, Bluetooth system 105, and a memory 106.

The handheld communication device can download an application that enables users to initiate a programming mode of a vehicle that the user has trouble otherwise initiating. For example, the user may have recently bought a replacement remote access device that can transmit access codes to the user's vehicle type but cannot start the programming sequence needed for the user's vehicle to recognize the remote access device.

The application stores a list of supported vehicle types 107 into the memory. For each supported vehicle type, the memory also stores a communication procedure 108 that enables programming and an instruction set 109 to guide a user through the programming process. The user can select a vehicle type that the user desires to program. The processor will use either the antenna, Bluetooth system, or other communication system (not shown) to run the communication procedure. The processor also displays a set of instructions for the user to follow. In a different example, the information can be stored remotely and retrieved into the memory as needed.

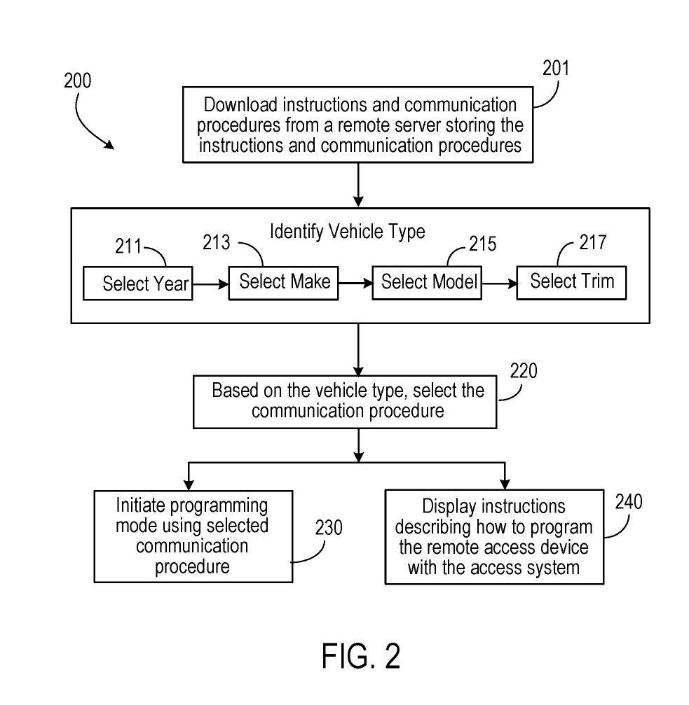

FIG. 2 is a flowchart 200 of an example method 200 performed by the handheld wireless communication device 100 of FIG. 1 to program a vehicle's remote access system to subsequently operate with a remote access device.

A server, such as a remote server accessible through the internet, stores instructions and communication procedures. The wireless handheld communication device downloads 201, from the server, one or more instructions and one or more communication procedures. The communication device may download all of the instructions and procedures. In other examples, the device downloads single instructions and procedures as needed.

The program displays supported vehicle types and, in response, the user identifies 210 the type of vehicle that the user desires to program. The user may select a year 211, make 213, model 215, and trim 217 as necessary. A user might not need to select every detail because some types of different vehicles use the same programming process.

The communication device selects 220 the proper communication procedure to program the selected vehicle type. If multiple procedures work with a vehicle type, the application may let the user select one of the procedures.

The communication device initiates a programming mode with the vehicle's remote access system using the selected communication procedure. This can include transmitting information to the vehicle access system using either the antenna 104 or Bluetooth system 105. Often, programming a replacement remote access device requires additional interaction from the user. In such cases, the communication devices outputs, e.g., by displaying on the screen 102 or announcing aloud through a speaker (not shown), instructions that the user must perform in order to finish programing the vehicle access system. Examples of such instructions typically include turning on the vehicle, pressing certain buttons on the replacement remote access device, or manually locking and unlocking the vehicle.

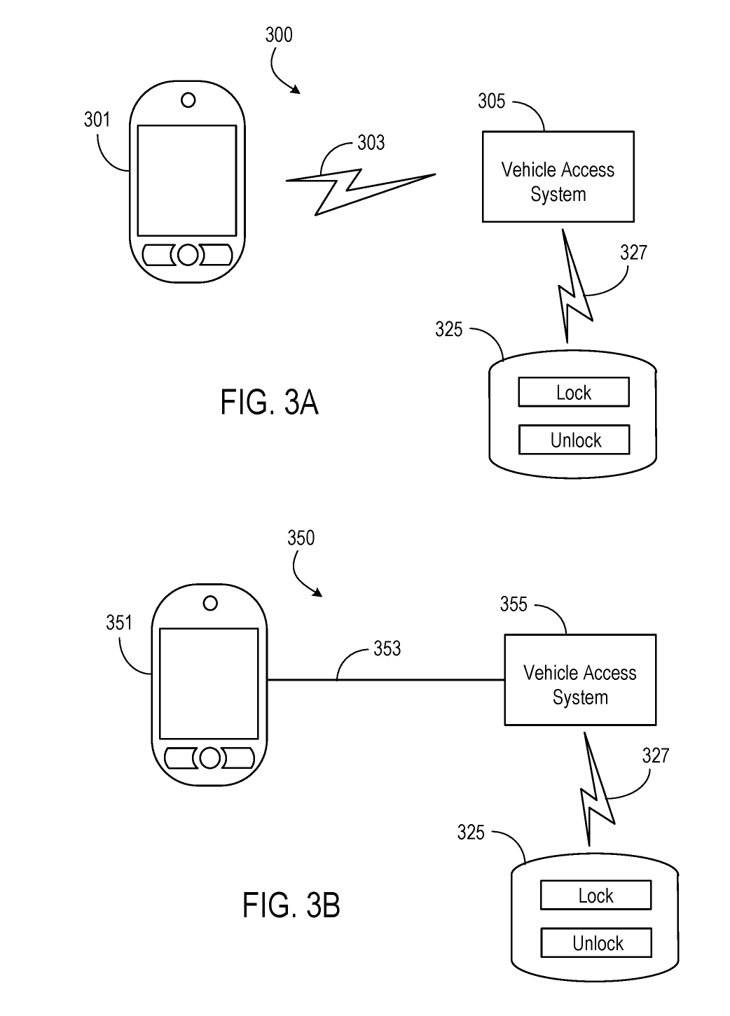

FIG. 3A shows a handheld communication device programming 300 a vehicle access system for operation with a remote access device. A smartphone 301, following a communication procedure, uses its antenna to wirelessly communicate 303 with the vehicle access system 305 to initiate a programming process. When the programming process completes, remote access device 325 can send wireless commands 327 to the vehicle access system to operate functions of the vehicle, such as lock or unlock.

FIG. 3B shows a handheld communication device programming 350 a vehicle access system for operation with a remote access device. A smartphone 351 physically connects 353 to the vehicle access system 355. The smartphone, following a communication procedure, sends wired signals to the vehicle access system to initiate a programming process. When the programming process completes, remote access device 325 can send wireless commands 327 to the vehicle access system to operate functions of the vehicle, such as lock or unlock.

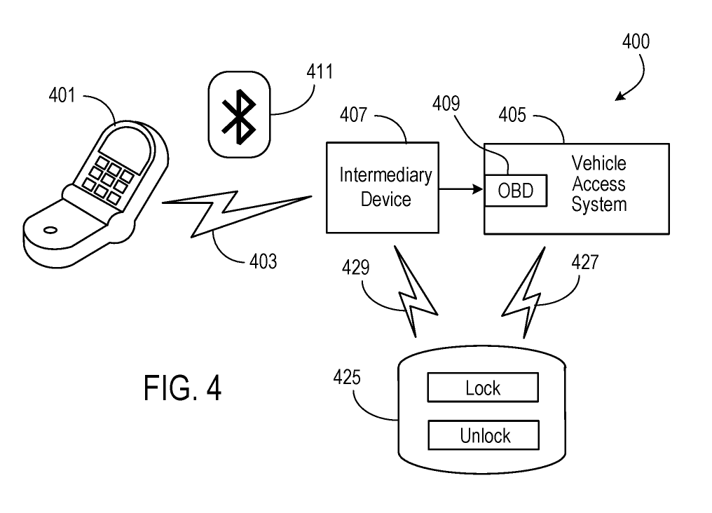

FIG. 4 shows a handheld communication device programming 400, through an intermediary device, a vehicle access system for operation with a remote access device. A cellular phone 401 uses Bluetooth 411 to wirelessly communicate 403 with an intermediary device 407. The intermediary device physically connects to the vehicle access system through a port such as an on-board diagnostic port 409. When the intermediary device receives the wireless communication 403, it sends wired commands to start programming the vehicle access system. When the programming completes, remote access device 425 can send wireless commands 427 to the vehicle access system to operate functions of the vehicle. In other examples, the remote access device 425 can send wireless commands 429 to the intermediary device, which then sends wired commands to the vehicle access system to operate functions of the vehicle.

The intermediary device can perform one or more other tasks. For example, it can read vehicle diagnostics, report the vehicle's status, immobilize the vehicle, log data, track the vehicle's location, or perform other tasks. The intermediary device can report the information to the vehicle's owner or to a service provider. It allows for remote wireless access to vehicle functionality otherwise requiring local access from inside the vehicle or with a physical connection to the vehicle.

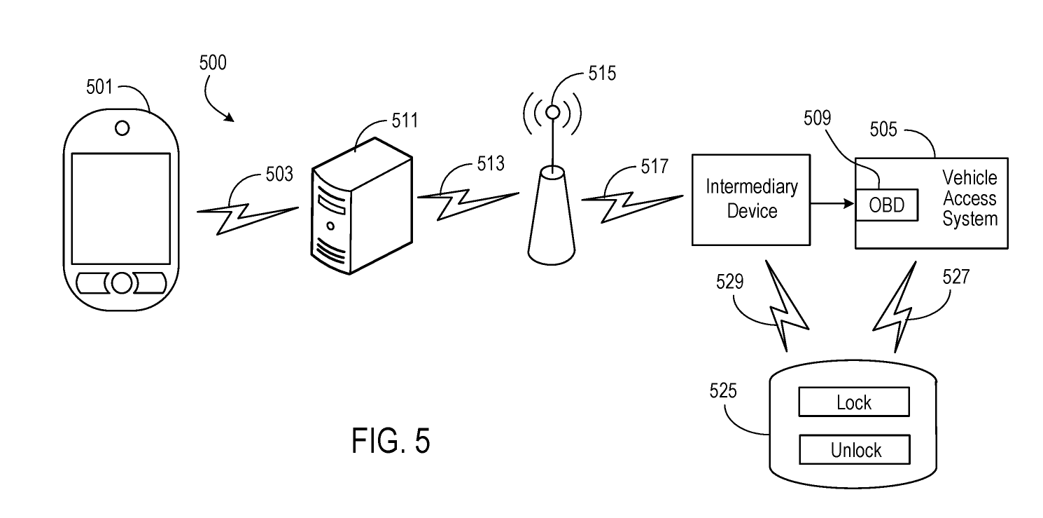

FIG. 5 shows a handheld communication device programming 400, through an intermediary service, a vehicle access system for operation with a remote access device. A smartphone 501 uses Wi-Fi 503 to send a command to an internet server 511. The internet server then communicates 513 to a wireless station such as cell station 515 to send a cellular signal 517 to the intermediary device 507. The intermediary device physically connects to the vehicle access system through a port such as an on-board diagnostic port 509. When the intermediary device receives the cellular communication 517, it sends wired commands to start programming the vehicle access system. When the programming completes, remote access device 525 can send wireless commands 527 to the vehicle access system to operate functions of the vehicle. In other examples, the remote access device 525 can send wireless commands 529 to the intermediary device, which then sends wired commands to the vehicle access system to operate functions of the vehicle.

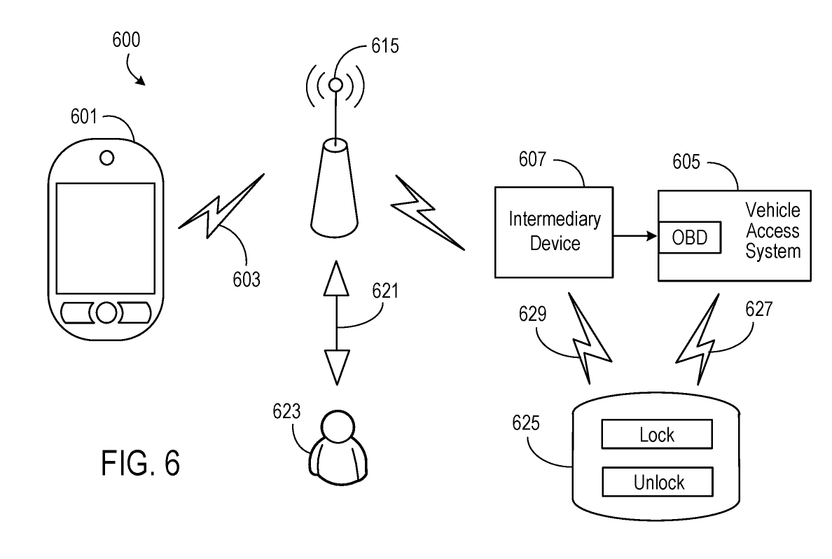

FIG. 6 shows a handheld communication device programming, through an intermediary service, a vehicle access system for operation with a remote access device. A vehicle's owner uses a telephone to make a telephone call 603 through a cellular network 615.

A service operator 623 receives the call. The service operator may request information from the vehicle's owner. Such information can include information about the vehicle's owner, the vehicle that the owner wants to program, the remote access device 625, and the intermediary device 607. The service provider uses an application, e.g., that performs the method shown in FIG. 2. The service provider inputs the vehicle information, and the application sends an appropriate communication procedure signal 617 through the cellular network to the intermediary device 607. The intermediary device physically connects to the vehicle access system through a port such as an on-board diagnostic port 609. When the intermediary device receives the appropriate communication procedure signal 617, it sends wired commands to start programming the vehicle access system.

When the programming completes, remote access device 625 can send wireless commands 627 to the vehicle access system to operate functions of the vehicle. In other examples, the remote access device 625 can send wireless commands 629 to the intermediary device, which then sends wired commands to the vehicle access system to operate functions of the vehicle. In other examples, a user can call the service provider 623 over cellular network 615 with a request to operate one of the vehicle's functions. The service provider 623 sends a cellular signal to the to the intermediary device, which then sends wired commands to the vehicle access system to operate functions of the vehicle.

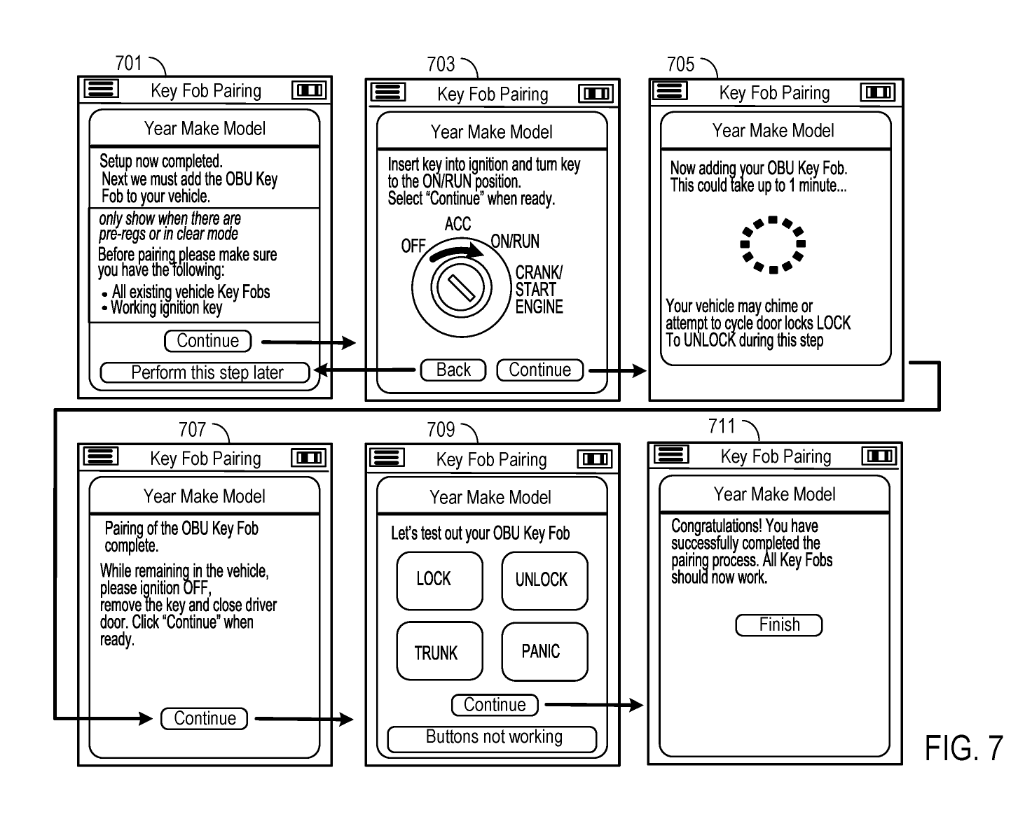

FIG. 7 shows a series 700 of screen shots of an application interface as the application runs on a smartphone. After a user selects a vehicle type, interface 701 displays instructions to the user to take actions to enable programming mode. After the user follows the instructions, the smartphone follows a specific communication procedure to send signals to the vehicle to initiate a programming mode. Interface 703 and 705 show the progress and update the user on the status. The application interface may instruct the user to take more actions (not shown) if necessary. The application interface 707 shows when programming is complete. The application interface 709 guides the user to test out the programmed remote access device and application interface 711 confirms successful programming.

A number of embodiments of the invention have been described. Nevertheless, it will be understood that various modifications may be made without departing from the spirit and scope of the invention. For example, the invention may use a plurality of remote access devices. The remote access devices can be replacement key fobs, original key fobs, or another device capable of remote communication such as a smartphone, including the same smartphone used to run the application. The intermediary device may reside inside the vehicle but wirelessly communicate with the access system. Communication to the vehicle access system may occur through an immobilizer. Accordingly, other embodiments are within the scope of the following claims.

1-20. (canceled)

21. A method, performed by a mobile communication device comprising a processor and a display, for facilitating pairing a remote access device with a vehicle, the method comprising:
downloading one or more communication procedures from an internet server to the mobile communication device;
displaying, on the display, an input menu including one or more vehicle options associated with a plurality of vehicle types supported by the downloaded communication procedures;
receiving one or more selections of the vehicle options from a user;
identifying, based on the received selections of the vehicle options from the user, a vehicle type for the vehicle from the plurality of vehicle types supported by the downloaded communication procedures;
selecting, by the processor and based on the identified vehicle type, a communication procedure operable with an access system of the vehicle from the downloaded communication procedures;
initiating, by the processor, a programming mode with the access system by using the selected communication procedure; and
displaying, on the display, instructions to the user describing how to pair the remote access device with the access system of the vehicle.

22. The method of claim 21, wherein the selected communication procedure comprises transmitting a wireless signal to the access system.

23. The method of claim 21, wherein a different communication procedure of the communication procedures comprises transmitting a wired signal through an on board diagnostic port to the access system.

24. The method of claim 21, wherein the selected communication procedure comprises transmitting a wireless signal to an intermediary device, the intermediary device configured to transmit another signal to the access system upon receiving the wireless signal.

25. The method of claim 24, wherein the intermediary device is physically coupled to the access system, and wherein the another signal is a wired signal.

26. The method of claim 24, wherein transmitting a wireless signal to the intermediary device comprises transmitting a first wireless signal to a wireless station, the wireless station configured to transmit a second wireless signal to the intermediary device.

27. The method of claim 25, further comprising receiving a status report from the access system,
wherein the intermediary device is coupled to the access system via an on board diagnostic port, the intermediary device configured to request the status report from the access system and also configured to send the status report to the device.

28. The method of claim 21, further comprising:
downloading one or more instructions sets from the internet server to the mobile communication device; and
selecting, by the processor and based on the identified vehicle type for the vehicle, an instructions set operable with the access system from the downloaded instructions sets,
wherein the plurality of vehicle types is supported by the downloaded instruction sets, and displaying instructions to the user comprises displaying the instructions of the selected instructions set to the user.

29. The method of claim 21, further comprising:
storing a plurality of communication procedures to communicate with different access systems of different vehicle types; and
storing a plurality of instructions sets describing different ways to program remote access devices of different vehicle types.

30. A mobile communication device comprising:
a memory configured to store one or more communication procedures;
a display screen configured to display an input menu including one or more vehicle options associated with a plurality of vehicle types supported by the stored communication procedures;
an input system configured to:
receive one or more selections of the vehicle options from a user, and
identify a vehicle type for a vehicle from the plurality of vehicle types based on the received selections;
a processor configured to:
select, based on the identified vehicle type, a communication procedure operable with an access system of the vehicle from the stored communication procedures, and
initiate a programming mode with the access system by using the selected communication procedure; and
a communication system configured to implement the selected communication procedure to pair a remote access device with the access system of the vehicle,
wherein the display system is configured to display instructions to the user describing how to pair the remote access device with the access system.

31. The device of claim 30, wherein the selected communication procedure comprises transmitting a wireless signal to the access system.

32. The device of claim 30, wherein a different communication procedure of the communication procedures comprises transmitting a wired signal through an on board diagnostic port to the access system.

33. The device of claim 30, wherein the selected communication procedure comprises transmitting a wireless signal to an intermediary device, the intermediary device configured to transmit another signal to the access system upon receiving the wireless signal.

34. The device of claim 33, wherein the intermediary device is physically coupled to the access system, and wherein the another signal is a wired signal.

35. The device of claim 34, wherein transmitting a wireless signal to the intermediary device comprises transmitting a first wireless signal to a wireless station, the wireless station configured to transmit a second wireless signal to the intermediary device.

36. The device of claim 34, wherein the communication system is configured to receive a status report from the access system; and
wherein the intermediary device is coupled to the access system via an on board diagnostic port, the intermediary device configured to request the status report from the access system and to send the status report to the device.

37. The device of claim 30, wherein the input system is configured to:
download the one or more communication procedures from an internet server to the mobile communication device.

38. The device of claim 30, wherein the memory is configured to:
store a plurality of communication procedures to communicate with different access systems of different vehicle types, and
store a plurality of instructions sets describing different ways to program remote access devices of different vehicle types.

39. The device of claim 38, wherein the processor is configured to:
select, based on the identified vehicle type for the vehicle, an instructions set operable with the access system from the stored instructions sets,
wherein the plurality of vehicle types are supported by the stored instruction sets, and the selected instructions set comprises the instructions displayed to the user.

40. A non-transitory computer storage medium encoded with a computer program for facilitating pairing a remote access device with a vehicle, the computer program comprising instructions that, when executed by a mobile communication device, cause the mobile communication device to perform operations comprising:
downloading one or more communication procedures from an internet server to the mobile communication device;
displaying an input menu including one or more vehicle options associated with a plurality of vehicle types supported by the downloaded communication procedures;
receiving one or more selections of the vehicle options from a user;
identifying, based on the received selections of the vehicle options from the user, a vehicle type for the vehicle from the plurality of vehicle types supported by the downloaded communication procedures;
selecting, based on the identified vehicle type, a communication procedure operable with an access system of the vehicle from the downloaded communication procedures;
initiating a programming mode with the access system by using the selected communication procedure; and
displaying instructions to the user describing how to pair the remote access device with the access system of the vehicle.
